(19) United States
(12) Patent Application Publication
(10) Pub. No.: US 2025/0026244 A1
(43) Pub. Date: Jan. 23, 2025

(54) COCKPIT FOR A MOTOR VEHICLE AND METHOD FOR THE RECONFIGURATION OF A COCKPIT

(71) Applicant: FERRARI S.P.A., Modena (MO) (IT)

(72) Inventors: Vito CONIGLIARO, Modena (MO) (IT); Alessandro Paolo DE PAOLI, Modena (MO) (IT); Thomas GRANJARD, Modena (MO) (IT); Daniel Martin TAYLOR, Modena (MO) (IT)

(73) Assignee: FERRARI S.P.A., Modena (MO) (IT)

(21) Appl. No.: 18/772,546

(22) Filed: Jul. 15, 2024

(30) Foreign Application Priority Data
Jul. 20, 2023 (IT) 102023000015249

(51) Int. Cl. B60N 2/01; B60N 2/64

(52) U.S. Cl. CPC B60N 2/01; B60N 2/64

(57) ABSTRACT

A cockpit for a motor vehicle is described, comprising: a frame, a first and a second seat cushion; a first and a second backrest; and a first and a second side; the cockpit can be arranged to a first configuration, in which the first seat cushion, the first backrest and the first side define a first seat for a passenger; and the second seat cushion, the second backrest, and said second side define a second seat for a driver; the cockpit can be movable to a second configuration, in which a third seat cushion, a third backrest, the first side and second side define one single third seat for a driver; said first side and second side being interposed between said first seat and said third seat and between said third seat and said second seat, respectively; the first side and the second side diverge in the second configuration of said cockpit.

### CROSS-REFERENCE TO RELATED APPLICATIONS

This patent application claims priority from Italian patent application no. 102023000015249 filed on Jul. 20, 2023, the entire disclosure of which is incorporated herein by reference.

### TECHNICAL FIELD

This invention relates to a cockpit for a motor vehicle and a method for reconfiguring the cockpit.

### BACKGROUND

Motor vehicles comprise, in a known way:
a passenger compartment defining a body; multiple wheels;
a steering wheel arranged inside the passenger compartment which can be driven by a driver to steer the front wheels and thus enable the motor vehicle to follow a curved trajectory; and
pedals comprising an accelerator and a brake that the driver can activate to increase the drive torque or exert a braking torque on the wheels respectively, so as to control the speed of the motor vehicle.

The passenger compartments of motor vehicles normally intended for use on the road implement the so-called “two-seater” configuration.

In this “two-seater” configuration, the passenger compartment also comprises a pair of front seats intended to be occupied by a driver and a passenger respectively, and arranged next to each other along a transverse direction of the motor vehicle orthogonal to a longitudinal direction defining a normal forward direction of the motor vehicle.

The steering wheel and the pedals are located opposite the driver's seat and are basically arranged in a left or right front corner of the vehicle.

With particular reference to sports motor vehicles, passenger compartments are known that implement the so-called “single-seater” configuration.

In this “single-seater” configuration, the passenger compartment comprises a single front seat arranged in a central position opposite the steering wheel and the pedals or passenger seats arranged to the side and/or set back from the central seat.

There is a need in the sector to provide motor vehicles that enable simple and easy reconfiguration between the above-mentioned “single-seater” and “two-seater” configurations.

### SUMMARY

The purpose of this invention is to produce a cockpit, which makes it possible to meet the need mentioned above.

The above-mentioned purpose is achieved with this invention, as it relates to a cockpit according to what is disclosed herein and presented in the claims.

This invention also relates to a method for reconfiguring a cockpit according to what is disclosed herein and presented in the claims.

### BRIEF DESCRIPTION OF THE DRAWINGS

In order to better understand this invention, two non-limiting preferred embodiments thereof will now be described by way of example with reference to the accompanying drawings, in which:

FIG. 1 is a perspective view of a motor vehicle comprising a first embodiment of a cockpit produced according to the precepts of this invention with parts removed for clarity;

FIG. 2 is a perspective view on a very enlarged scale of the first embodiment of the cockpit in FIG. 1, with parts removed for clarity and, in a first, “single-seater” operating configuration;

FIG. 3 is a perspective view on a very enlarged scale of the first embodiment of the cockpit in FIG. 1, with parts removed for clarity and, in a second, “two-seater” operating configuration;

FIG. 4 is a perspective view on a very enlarged scale of a second embodiment of the cockpit in FIGS. 1 to 3, with parts removed for clarity and in a first, “single-seater” operating configuration;

FIG. 5 is a perspective view on a very enlarged scale of the second embodiment of the cockpit in FIG. 5, with parts removed for clarity and in a first, “two-seater” operating configuration;

FIG. 6 is a perspective view from below on a very enlarged scale of the cockpit in Figures 4 and 5;

FIG. 7 is a rear view of the cockpit in FIG. 6;

FIG. 8 illustrates, on an even more enlarged scale and in perspective view according to a first visual angle, a seat of the cockpit in FIGS. 6 and 7;

FIG. 9 illustrates the seat in FIG. 8 in a side view;

FIGS. 10 to 12 illustrate, in a very enlarged perspective view, respective first details of the seat in FIGS. 8 and 9; and

FIGS. 13 to 15 illustrate, in a very enlarged perspective view, second details of the seat in FIGS. 8 and 9.

### DESCRIPTION OF EMBODIMENTS

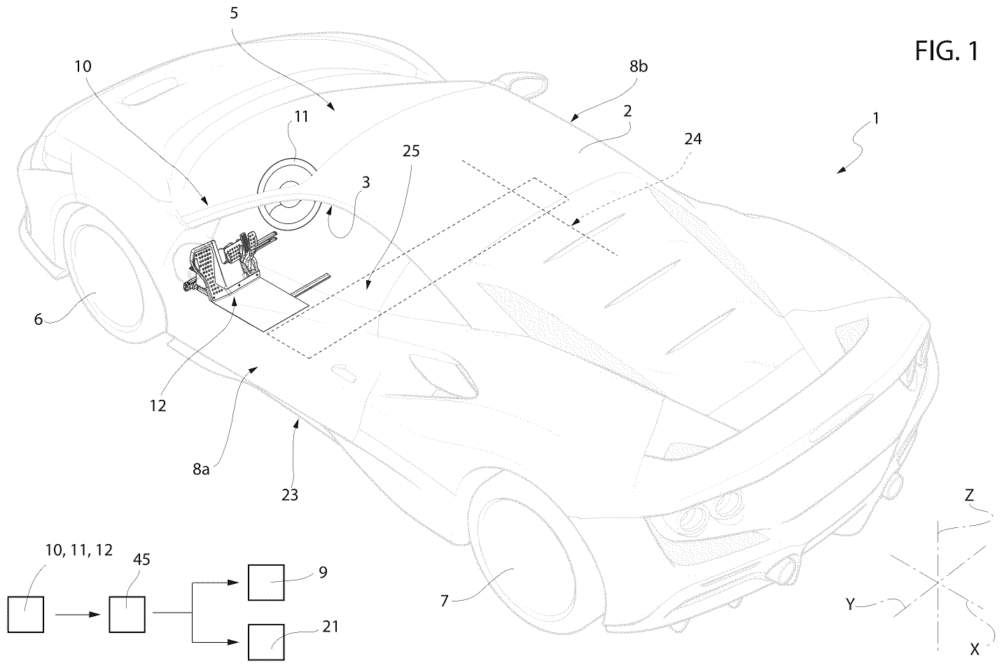

With reference to FIG. 1, reference number 1 indicates a motor vehicle comprising a body 2 defining a passenger compartment 3.

It should be specified that, below in this description, expressions such as “above”, “below”, “in front of”, “behind” and the like are used with reference to the normal movement of the motor vehicle 1.

It is also possible to define:
a longitudinal axis X integral with the motor vehicle 1, arranged, in use, horizontal and parallel to a normal forward moving direction of the motor vehicle 1;
a transversal axis Y integral with the motor vehicle 1, arranged, in use, horizontal and orthogonal to the axis X; and
an axis Z integral with the motor vehicle 1, arranged, in use, vertical and orthogonal to the axes X, Y.

The motor vehicle 1 also comprises (FIG. 1):
a pair of front wheels 6 and a pair of back wheels 7;
a known engine 9 only schematically illustrated in FIG. 1 and operationally connected to the wheels 6 and/or 7 to exert drive torque on the wheels 6 and/or 7; and
a brake system 21, also only schematically illustrated, in FIG. 1 that can be driven to exert a braking torque on the wheels 6, 7.

The motor vehicle 1 also comprises (FIG. 1):
a windscreen 5 delimiting the passenger compartment 3 at the front; and
a pair of doors 8a, 8b hinged to the body 2 that can be moved between a closed position wherein they delimit the passenger compartment 3 to the side and prevent entry into/exit from the passenger compartment 3 and an open position wherein they enable entry into/exit from the passenger compartment 3.

The body 2 also comprises a pair of door sills 23, 24 with longitudinal ends opposite each other. The door sills 23, 24 delimit the passenger compartment 3 and are adjacent to corresponding doors 8a, 8b when the doors 8a, 8b are in the respective closed positions.

The motor vehicle 1 also comprises control members 10 arranged in the passenger compartment 2 that the driver can activate to set a forward trajectory of the motor vehicle 1 with a desired speed.

In a known way, the control members 10 comprise:
a steering wheel 11 arranged inside the passenger compartment 2 that the driver can activate; and
pedals 12 also arranged inside the passenger compartment 2 that the driver can activate.

The control members 10 are connected to the engine 9, to the brake system 21, and to the wheels 6 and/or 7 implementing a technology known in the sector as “drive by wire”.

In this description, the term “drive by wire” mode means that the steering wheel 11 does not have physical or mechanical connections with the wheels 6, 7.

The motor vehicle 1 also comprises a control unit 45 (FIG. 1) programmed to receive, as input, the actions requested at the steering wheel 11 and pedals 12, and to generate, as output, control signals for the engine 9 and the brake system 21.

The passenger compartment 3 houses a front cockpit 25, only schematically illustrated in FIG. 1, in a known way.

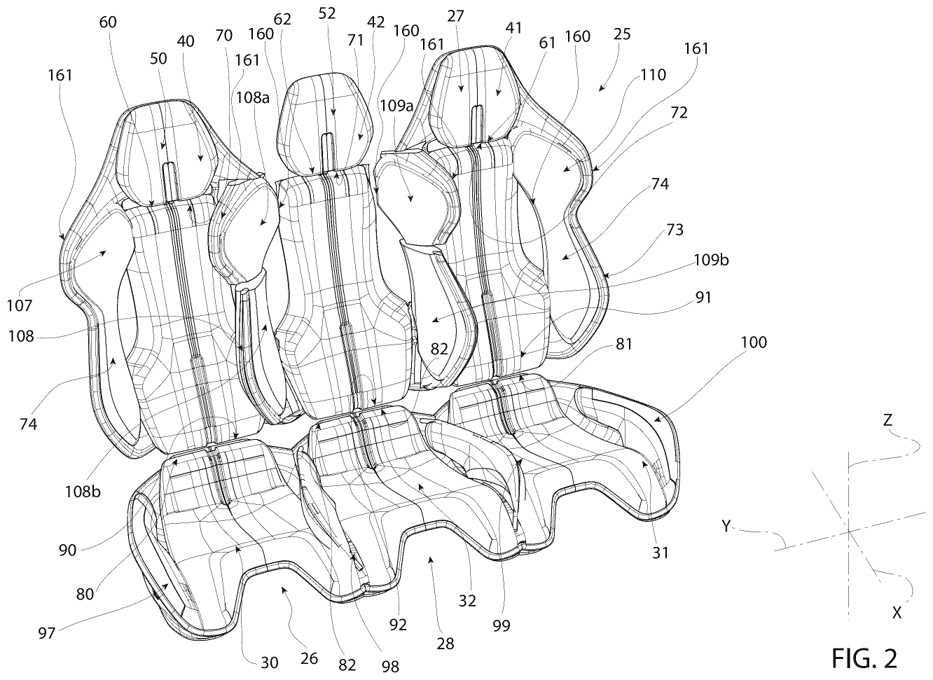

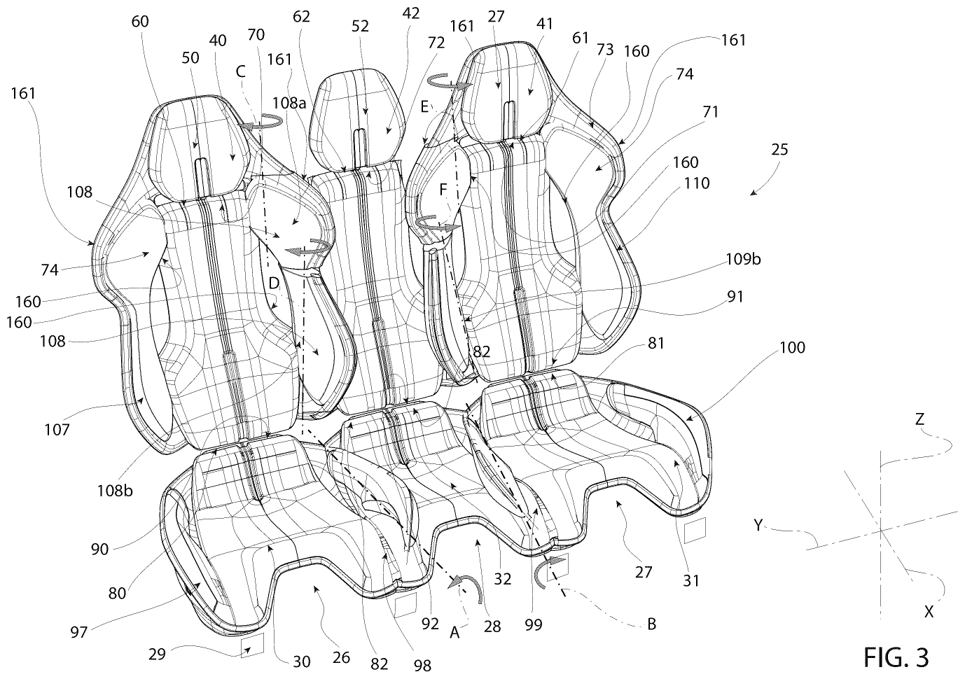

The cockpit 25 can be selectively moved between:
a first, “single-seater” configuration illustrated in FIG. 2, wherein it defines a seat 26 for a passenger and a seat 27 for a driver arranged next to each other and spaced apart along their axis Y; and
a “two-seater” configuration illustrated in FIG. 3, wherein it defines a single seat 28 for the driver.

With particular reference to FIGS. 2 and 3, the cockpit 25 comprises:
a frame 29 fixed to the body 2;
multiple, three in the example illustrated, seat cushions 30, 31, 32 placed next to each other along the axis Y;
multiple, three in the example illustrated, backrests 40, 41, 42 placed next to each other along the axis Y; and
multiple, three in the example illustrated, headrests 50, 51, 52 placed next to each other along the axis Y.

Each seat cushion 30, 31, 32 is connected with a corresponding backrest 40, 41, 42 and a corresponding headrest 50, 51, 52.

Each backrest 40, 41, 42 comprises, in particular:
a corresponding upper edge 60, 61, 62 extended along the axis Y and connected to a lower edge 70, 71, 72 of the corresponding headrest 50, 51, 52; and
a corresponding lower edge 80, 81, 82 extended along the axis Y and connected to a rear and upper edge 90, 91, 92 of the corresponding seat cushion 30, 31, 32.

The cockpit 25 also comprises:
multiple sides 97, 98; 99, 100; and
multiple sides 107, 109; 109, 110 arranged above the corresponding sides 97, 98; 99, 100.

Each seat cushion 30, 31 extends between a corresponding pair of sides 97, 98; 99, 100.

The sides 97, 98; 99, 100 are, in particular, arranged on corresponding opposite sides of the corresponding seat cushion 30, 31.

The sides, 98, 99 are also arranged on corresponding sides of the seat cushion 32.

The seat cushion 32 is placed between the seat cushions 30, 31 along the axis Y.

Similarly, each backrest 40, 41 extends between a corresponding pair of sides 107, 108; 109, 110.

The sides 107, 108; 109, 110 are, in particular, arranged on corresponding opposite sides of the corresponding backrest 40; 41.

The sides 108; 109 are also arranged on corresponding opposite sides of the backrest 42.

In particular, each side 97, 98; 99, 100; 107, 108; 109, 110 comprises:
a corresponding edge 160 fixed to the corresponding seat cushion 30; 31; backrest 40; 41; and
a corresponding free edge 161 opposite the corresponding edge 160.

The backrest 42 is interposed between the backrests 40, 41 along the axis Y.

Each backrest 40, 41, 42 is placed between a corresponding seat cushion 30, 31, 32 and a corresponding headrest 50, 51, 52.

In the example illustrated, the sides 108, 109 are each made of two corresponding, upper and lower half-sides 108a, 108b; 109a, 109b.

In the first, “two-seater” configuration, the seat 26 comprises the seat cushion 30, the backrest 40, and the headrest 50.

The seat 27 comprises the seat cushion 31, the backrest 41, and the headrest 51.

In the example illustrated in FIGS. 2 and 3, the sides 107, 108; 109, 110 each comprise a support 73 and a cushion 74 supported by the support 70.

Advantageously, the cockpit 25 can be moved into a second, “single-seater” configuration wherein it defines just the seat 28 for the driver formed by the seat cushion 32, the backrest 42, the sides 98, 99, 108, 109; the sides 98, 99; 108, 109 diverge from each other in the “single-seater” configuration, moving from the respective edges 160 towards the corresponding edges 161; the sides 98, 108 are placed between the seats 26, 28 and the sides 99, 109 are placed between the seats 28, 27.

The seat 28 also comprises the headrest 52.

More specifically, the sides 97, 107 are respectively fixed to the seat cushion 30 and to the backrest 40.

The sides 100, 110 are respectively fixed to the seat cushion 31 and to the backrest 41. The side 97, 107 and the side 100, 110 diverge from each other, moving from the corresponding edge 160 towards the corresponding edge 161.

The side 100 and the side 110 extend at the front of the corresponding seat cushion 40 and backrest 41, moving from the corresponding edge 160 towards the corresponding edge 161.

The transition of the cockpit 25 from the first to the second configuration and vice versa occurs thanks to:
the rotation of the sides 98, 99 in relation to the corresponding seat cushions 30, 31 and around the respective axes A, B; and
the rotation of the half-sides 108a, 108b; 109a, 109b in relation to the corresponding backrests 40, 41 and around the respective axes C, D; E, F.

The transition of the cockpit 25 from the first to the second configuration, and vice versa, also occurs manually or by driving an actuator (not illustrated).

The sides 98, 99 are assembled so that they can rotate in relation to the corresponding seat cushions 30, 31 around the corresponding axes A, B between:
respective first positions assumed when the cockpit 25 is in the first, “two-seater” configuration; and
respective second positions assumed when the cockpit 25 is in the second, “single-seater” configuration.

Similarly, the half-sides 108a, 108b, 109a, 109b are assembled so that they can rotate in relation to the corresponding backrests 40, 41 and around corresponding axes C, D, E, F between:
respective third positions assumed when the cockpit 25 is in the first, “two-seater” configuration; and
respective fourth positions assumed when the cockpit 25 is in the second, “single-seater” configuration.

More precisely, in the respective first positions, the sides 97, 98; 99, 100; 107, 108; 109, 110 are arranged so that they diverge from each other, moving from the respective edges 160 towards the corresponding edges 161.

The sides 98, 99 also converge at the front of the seat cushion 32, moving from the respective edges 160 towards the corresponding edges 161.

Similarly, the sides 108, 109 also converge at the front of the backrest 42, moving from the respective edges 160 towards the corresponding edges 161.

In the corresponding second positions, the sides 97, 98; 99, 10) are arranged parallel to each other.

The sides 98, 99 also diverge at the front of the seat cushion 32, moving from the respective edges 160 towards the corresponding edges 161.

Similarly, the sides 107, 108 (109, 110) are arranged parallel to each other.

The sides 108, 109 also diverge at the front of the backrest 42, moving from the corresponding edges 160 towards the corresponding edges 161.

The seat 26 is arranged next to the door sill 23 and the other seat 27 is arranged next to the other door sill 24, thus implementing a left-hand drive mode in the motor vehicle 1 in the first, “two-seater” configuration of the cockpit 25.

The seat 28 is arranged in a mid position between the door sills 23, 24.

In a way not described in detail since not necessary for this invention, the pedals 12 and the steering wheel 11 can be moved along the axis Y to encourage the transformation of the motor vehicle 1 between the first and second configuration.

In particular, the pedals 12 and the steering wheel 11 may be moved parallel to the axis Y between:
a fifth position (FIG. 1) assumed when the cockpit 25 is in the first, “two-seater” configuration and wherein they face the seat 27 defined by the cockpit 25; and
a sixth position assumed when the cockpit 25 is in the second, “single-seater” configuration and wherein they face the seat 28 defined by the cockpit 25.

The pedals 12 and the steering wheel 11 are arranged adjacent to the door sill 23 when they are arranged in the fifth position. In this fifth position, a first distance between the pedals 12 and the steering wheel 11, and the door sill 23 is less than a second distance between the pedals 12 and the steering wheel 11, and the door sill 24. The above-mentioned first and second distance are measured along the axis Y.

The pedals 12 and the steering wheel 11 are arranged in a position midway between the door sills 23, 24 when they are arranged in the sixth position. In this sixth position, the pedals 12 and the steering wheel 11 are equally spaced apart form the door sills 23, 24 along the axis Y.

During operation of the cockpit 25 and the motor vehicle, the passenger compartment 3 is in the first, “two-seater” configuration.

In this first, “two-seater” configuration, the cockpit 25 defines the seats 27, 26 for the driver and passenger respectively.

The seats 26, 27 are separated parallel to the axis Y by the seat cushion 32 and the backrest 42.

More specifically, the seat 26 is delimited by the sides 97, 107 and by the sides 98, 108 arranged in the respective first and third positions.

The seat 27 is delimited by the sides 99, 100 and by the sides 109, 110 arranged in the respective first and third positions.

Therefore, the sides 97, 98; 99; 100; 107, 108; 109, 110 are arranged so that they diverge from each other, moving from the respective edges 160 to the corresponding edges 161 so as to enable easy access for the driver and passenger to the respective seats 27, 26.

The sides 98, 99; 108, 109 are arranged so that they converge with each other, moving from the respective edges 160 to the corresponding edges 161.

The pedals 11 and the steering wheel 12 are arranged in the fifth position, wherein they face the seat 27 along the axis X, to enable the driver to guide them.

If one wishes to reconfigure the motor vehicle 1, so as to arrange the cockpit 25 in the second, “single-seater” configuration, it is enough to drive the actuator so as to cause:
the rotation of the sides 98, 99 in relation to the corresponding seat cushions 30, 31 and around the corresponding axes A, B starting from the respective first positions until reaching the corresponding second positions; and
the rotation of the half-sides 108a, 108b; 109a, 109b in relation to the corresponding backrests 40, 41 and around the corresponding axes C, D; E, F starting from the respective third positions until reaching the corresponding fourth positions.

With reference to FIG. 3, the cockpit 25 in the second, “single-seater” configuration defines just one seat 28 for the driver.

More specifically, the seat 28 is delimited by the sides 98, 108 and by the other sides 99, 109 arranged in the respective second and fourth positions.

Therefore, the sides 97, 98; 107, 108; 99, 100; 109, 110 are arranged parallel to each other and extend from respective opposite sides of the seat 28, moving from the respective edges 160 to the corresponding edges 161.

The sides 98, 99; 108, 109 diverge in front of the seat 28, moving from the respective edges 160 to the corresponding edges 161 so as to enable easy access for the driver and passenger to the seat 28.

The pedals 11 and the steering wheel 12 are also moved parallel to the axis Y, in a known way not illustrated, from the fifth position to the sixth position, wherein they face the seat 27 along the axis X, to enable the driver to guide them.

Irrespective of the fact that the cockpit 25 is in the first, “two-seater” configuration, or in the second, “single-seater” configuration, the control members 10 control the engine 9, the wheels 6, 7, and the brake system 21 implementing a technology known in the sector as “drive by wire”.

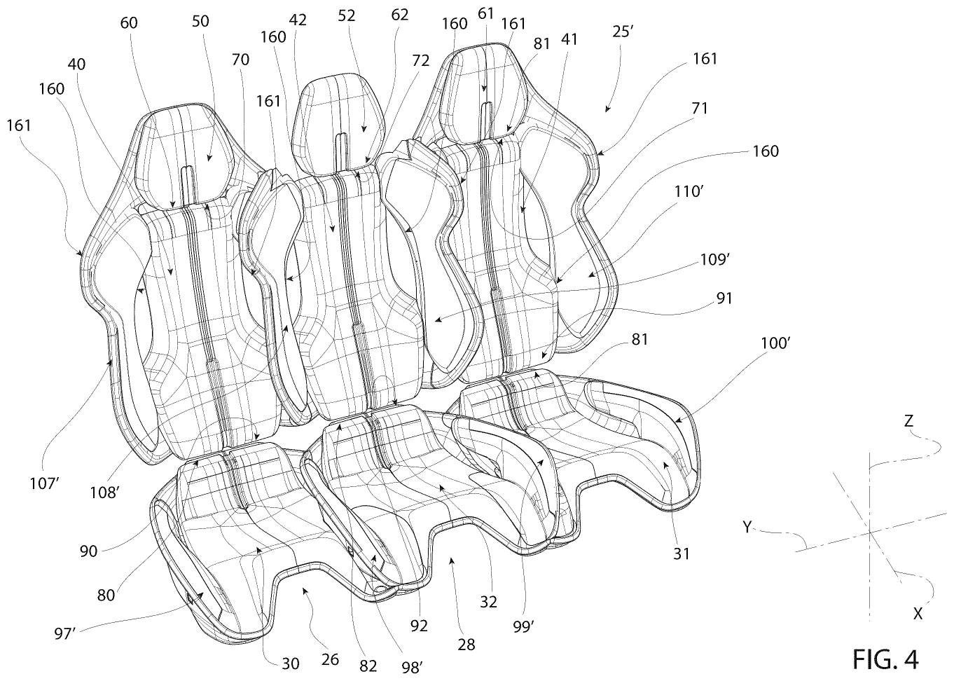

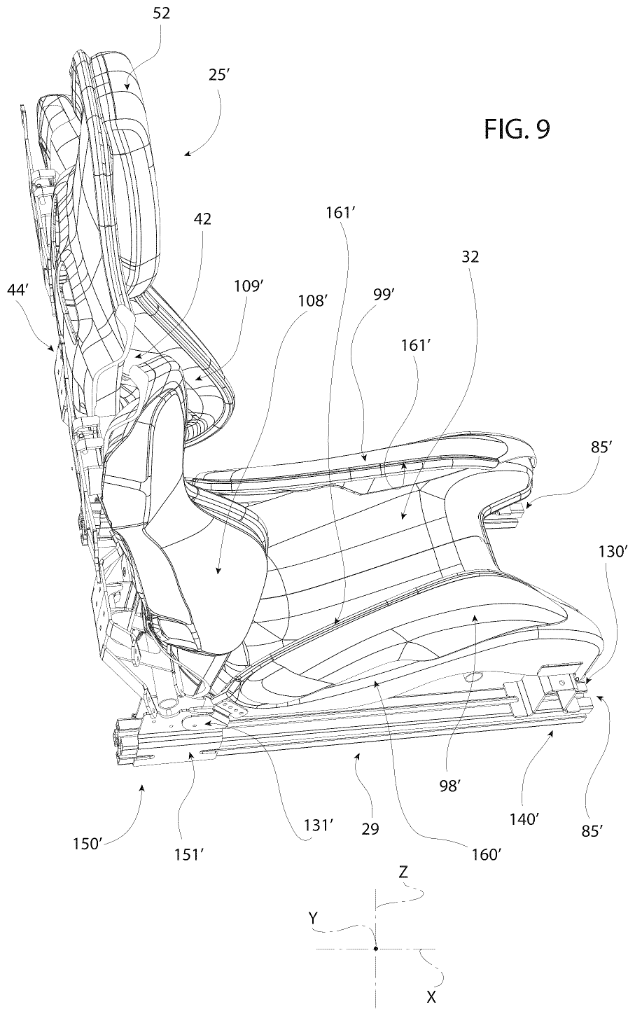

With reference to FIGS. 4 to 15, reference number 25′ indicates a cockpit according to a second embodiment of this invention.

The cockpit 25′ is similar to the first cockpit 25 and will be described below only as far as it differs from the latter; the same or equivalent parts of the systems 10, 10′ will be distinguished, where possible, by the same reference numbers.

The cockpit 25′ differs from the first cockpit 25, in that:
the sides 98′, 99′, 108′, 109′ are connected to the frame 29′ so that they can be released;
the sides 98′, 99′, 108′, 109′ cannot rotate in relation to the frame 29′, once they have been connected to the frame 29′; and
the sides 108′, 109′ are each made of a single element.

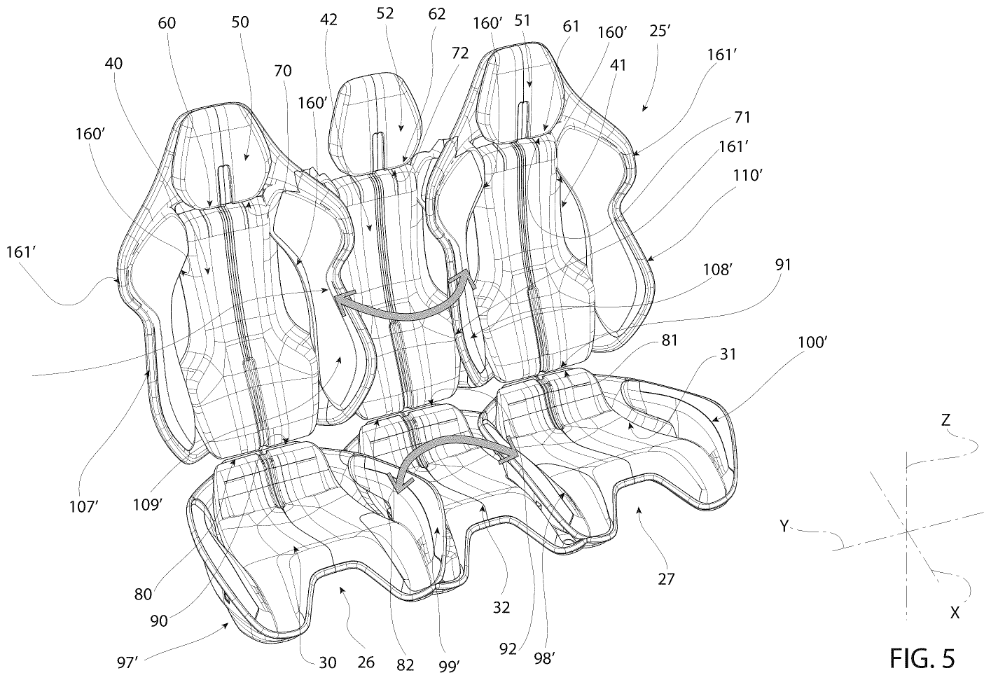

More specifically, in the first, “two-seater” configuration of the cockpit 25′ (FIG. 5), the sides 98′, 108′ are arranged on a first side of the seat cushion 32 and the sides 99′, 109′ are arranged on a second side, opposite the first side along the axis Y, of the seat cushion 32.

The sides 98′, 99′ and 108′, 109′ also converge, moving from the corresponding edges 160′ towards the corresponding edges 161′.

In the example illustrated, the first side is arranged on the side of the door sill 23 and the second side of the seat cushion 32 is arranged on the side of the door sill 24.

In the second, “single-seater” configuration of the cockpit 25′ (FIG. 4), the sides 98′, 108′ are arranged on the second side of the seat cushion 32 and the sides 99′, 109′ are arranged on the first side.

The sides 99′, 98′ and 109′, 108′ also diverge, moving from the corresponding edges 160′ towards the corresponding edges 161′.

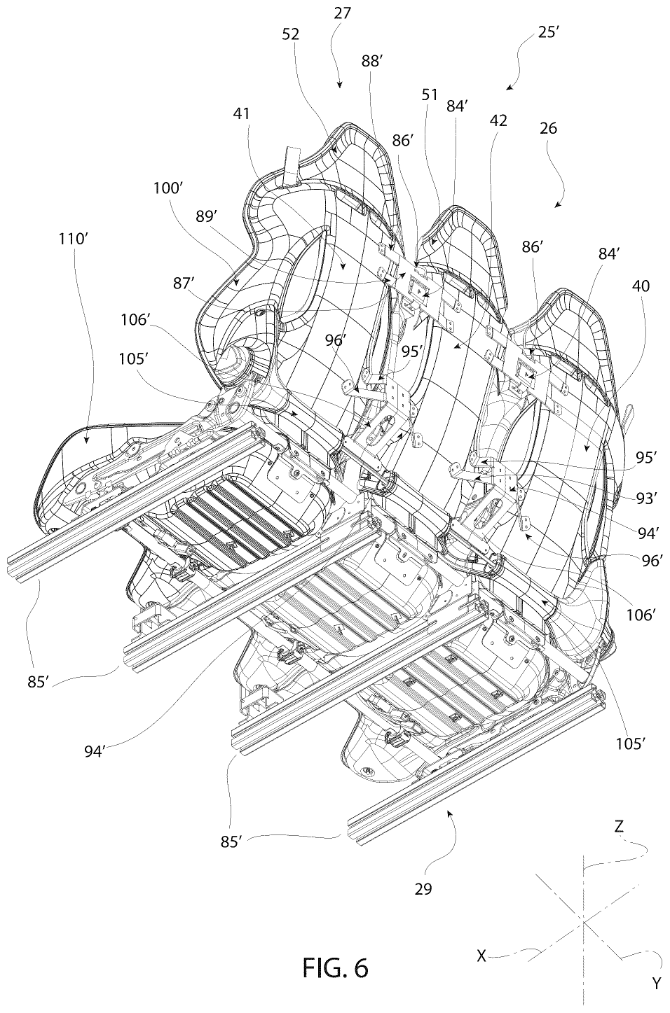

With reference to FIGS. 6 to 9 and 13 to 15, the frame 29′ comprises, in turn, multiple, four in the example illustrated, guides 85′ parallel to the axis X, spaced apart along the axis Y and arranged on the respective sides 97′, 98′, 99′, 100′ and on which the cockpit 25′ can slide.

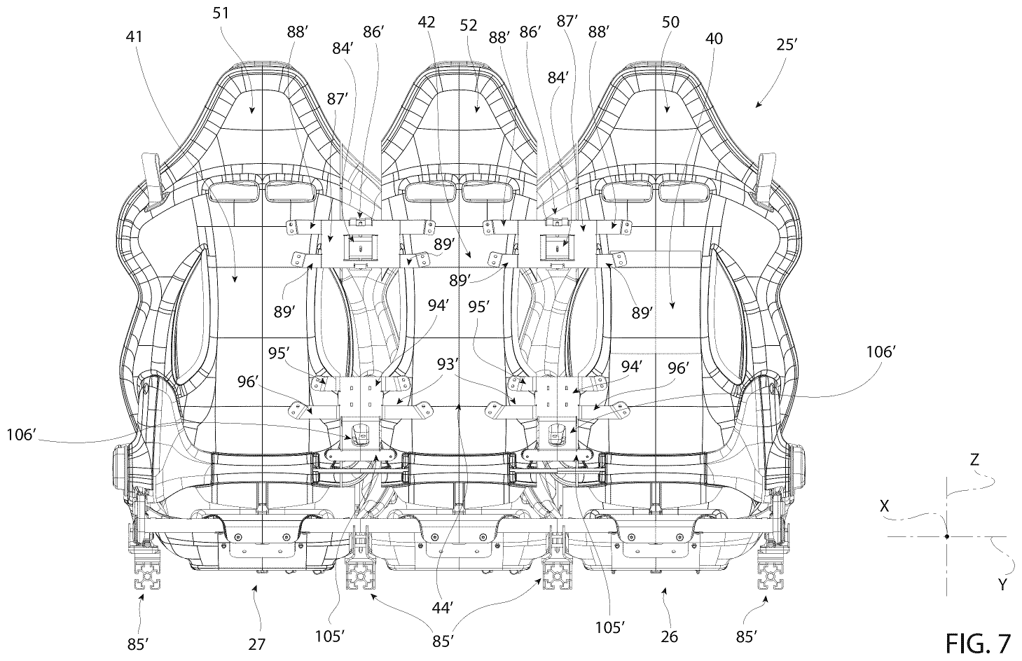

The cockpit 25′ also comprises (FIGS. 6 and 7):
a pair of upper brackets 86′, one of which connects the backrests 40, 42 to each other and the other of which connects the other backrests 41, 42 to each other; and
a pair of lower brackets 93′, one of which connects the backrests 40, 42 to each other and
the other of which connects the other backrests 41, 42 to each other.

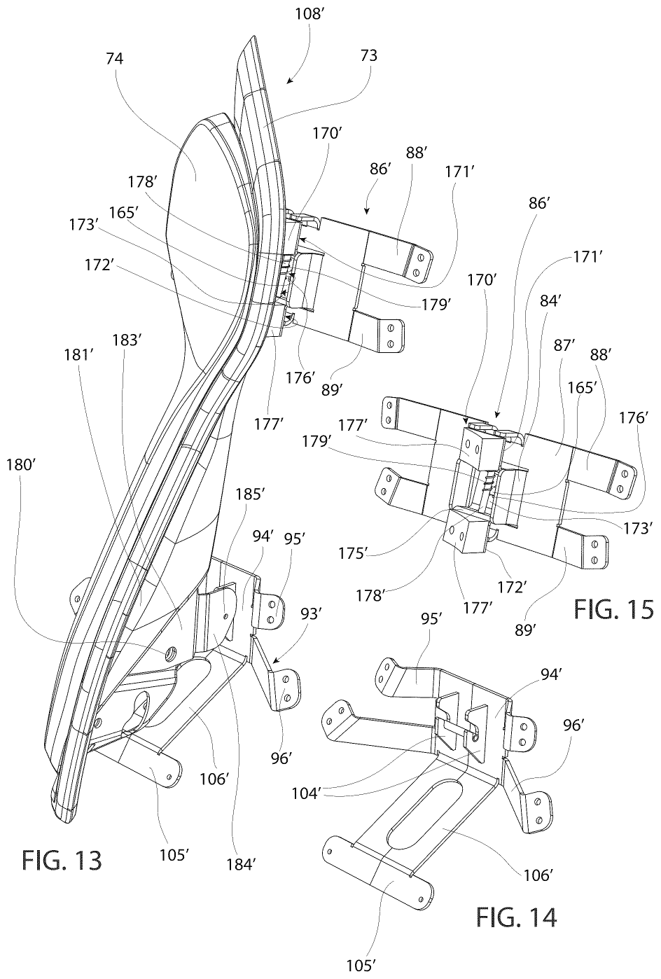

Each bracket 86′ comprises, in turn (FIGS. 13 and 15):
a plate 87′ defining a square opening 84′;
a pair of upper appendages 88′, projecting so they overhang from the respective opposite sides of the plate 87′ and defining respective attachment elements fixed to respective rear surfaces 44′ of the backrests 40, 42 (42, 41); and
a pair of lower appendages 89′, projecting so they overhang from respective opposite sides of the plate 87′ and defining respective attachment elements also fixed to respective rear surfaces 44′ of the backrests 40, 42 (42, 41).

The appendages 88′, 89 are extended parallel to the axis Y.

Each bracket 93′ comprises, in turn (FIGS. 13 and 14):
a plate 94′ defining a pair of seats 104′ spaced apart along the axis Y, open above and closed below in the direction parallel to the axis Z, and having a C-shaped cross-section on a plane orthogonal to the axis Y;
a pair of upper appendages 95′, projecting so they overhang from respective opposite sides of the plate 94′ and defining respective attachment elements fixed to respective rear surfaces 44′ of the backrests 40, 42 (42, 41);
a pair of lower appendages 96′, projecting so they overhang from the respective opposite sides of the plate 94′ and defining respective attachment elements also fixed to respective rear surfaces 44′ of the backrests 40, 42 (42, 41); and
a bar 105′ defining a pair of additional attachment elements fixed to the lower surfaces 44′ of the backrests 40, 42 (42, 41).

The seats 104′ are placed between the appendages 95′, 96 parallel to the axis Z. Each bracket 93′ also comprises a plate 106′ tilted in relation to the plate 94′ and interposed between the bar 105′ and the appendages 96′.

The appendages 95′, 96′ and the bar 105′ are extended parallel to the axis Y.

With reference to FIGS. 4 and 5 and 10 to 12, each side 98′, 99′ is connected so that it can be released to the corresponding guide 85′.

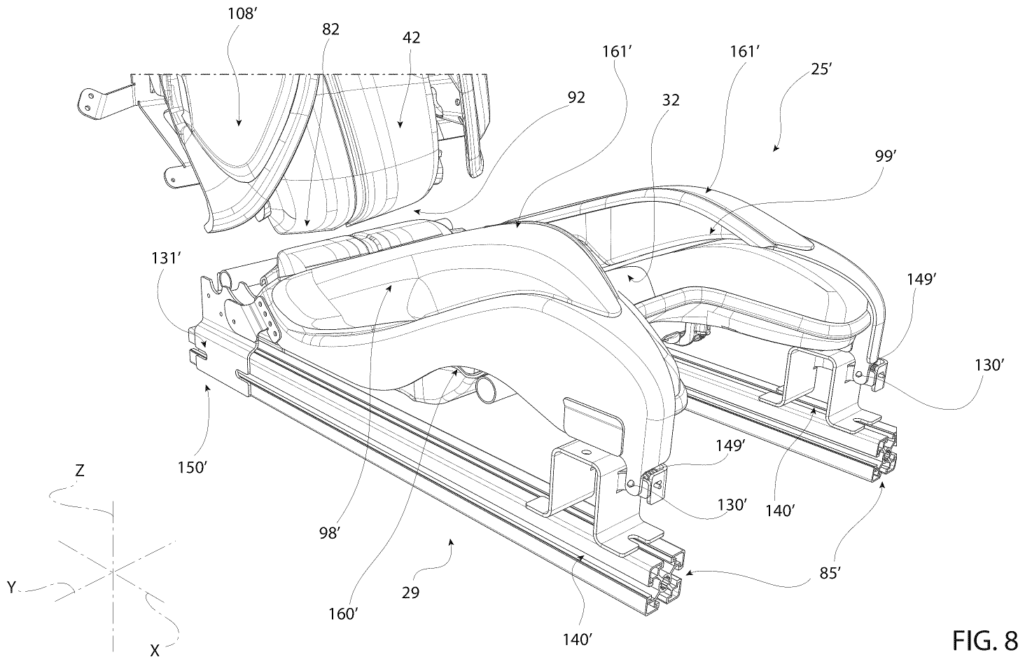

More specifically, each side 98′, 99′ comprises, in turn (FIGS. 8 to 12):
a front hole 130′ that can be coupled, so that it can be released, to a front bracket 140′ supported by a corresponding guide 85′; and
a rear attachment element 131′ that can be coupled, so that it can be released, to a rear bracket 150′ supported by a corresponding guide 85′.

Below in this description, only one side 98′, 99′, one bracket 140′, and one other bracket 150′ are described, the sides 98′, 99′ and the brackets 140′, 150′ being identical to each other.

More specifically, the hole 130′ and the attachment element 131′ define respective front and rear ends of the side 98′, 99′ and are spaced apart from each other parallel to the axis X, when the side 98′, 99′ is connected to the guide 85′.

The bracket 140′ comprises, more precisely (FIG. 12):
a support structure 142′ fixed to the guide 85′;
a pair of walls 143′ parallel to each other, arranged above the support structure 142′, and defining a seat 144′ extending along the axis X and open along the axis Z on the opposite side to the support structure 142′; and
a pair of walls 145′, 146′ projecting from the support structure 142′ and connected to each other at the front of the seat 144′ via a pin 149′ with an axis parallel to the axis Y.

The wall 146′ is bent towards the wall 145′ in front of the pin 149′.

The pin 149′ projects from the wall 145′ and engages the hole 130′ of the corresponding side 98′, 99′ when the latter is connected to the guide 85′.

The seat 144′ is engaged by a portion 141′ of the corresponding side 98′, 99′ when the latter is connected to the guide 85′.

In particular, the walls 143′ project from the support structure 142′ on the side opposite the relative guide 85′ with reference to the axis Z.

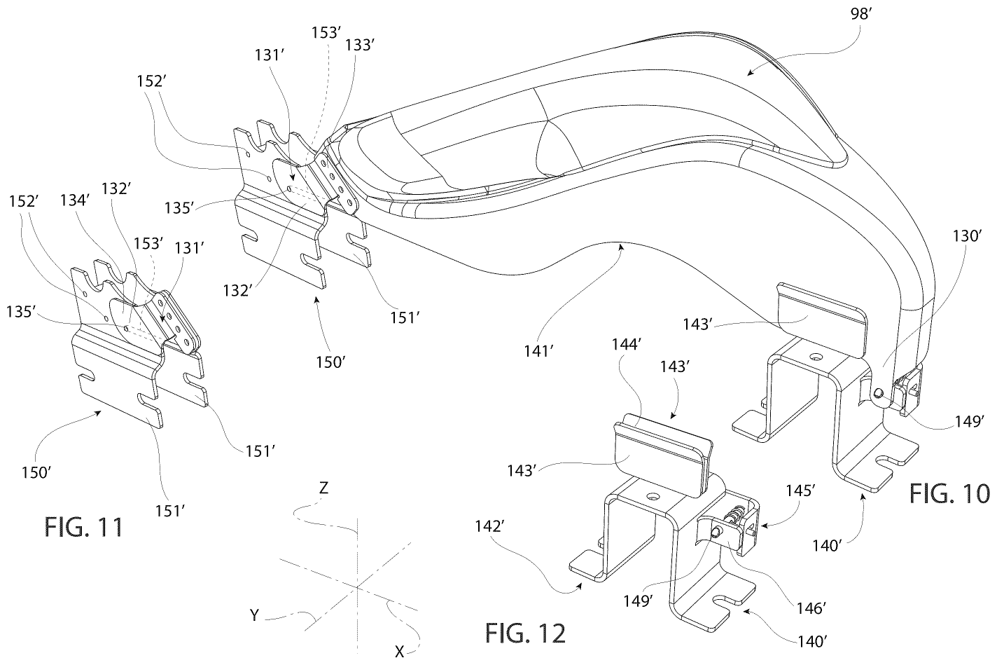

The attachment element 131′ comprises, in turn, a pair of walls 132′ (just one of which is visible in FIGS. 10 and 11) parallel and spaced apart, and having respective front ends 133′ fixed to the side 98′, 99′ and respective rear ends 134′ connected by a pin 135′ parallel to the axis Y.

The bracket 150′ comprises, in turn:
a pair of walls 151′ parallel to each other, spaced apart parallel to the axis Y and between which the guide 85′ extends; and
a pair of pins 152′ (only schematically illustrated in FIGS. 10 and 11), spaced apart along the axes Z, X and parallel to the axis Y, and placed between the walls 151′ so as to connect the walls 151′, keeping them at a desired distance parallel to the axis Y.

The walls 151′ define respective seats 153′ open at the front and closed at the rear, extended along the axis Y and engaged by the pin 135′ of the attachment element 131′.

The brackets 140′, 150′ of each guide 85′ are spaced apart along the axis X.

With reference to FIGS. 4 and 5 and 13 to 15, each side 108′, 109′ is connected to a corresponding bracket 86′ and a corresponding bracket 93 so that it can be released.

More specifically, each side 108′, 109′ comprises, in turn (FIGS. 13 to 15):
a corresponding attachment element 170′ that can be coupled, so that it can be released, to a corresponding bracket 86′ and arranged above when the side 108′, 109′ is connected to the backrest 42; and
a corresponding attachment element 180′ that can be coupled, so that it can be released, to a corresponding bracket 93′ and arranged below when the side 108′, 109′ is connected to the backrest 42.

Below in this description, only one side 108′, 109′, one attachment element 170′, one other attachment element 180′, one bracket 86′, and one other bracket 93′ are described, the sides 108′, 109′, the attachment elements 170′, 180′, and the brackets 86′, 93′ being identical to each other.

More specifically, the attachment element 170′ and the attachment element 180′ define respective upper and lower ends of the side 108′, 109′ and are spaced apart from each other parallel to the axis Z, when the side 98′, 99′ is connected to the backrest 42.

The attachment element 170′ comprises, in turn:
a pair of walls 171′, 172′, respectively upper and lower;
a wall 173′ placed between the walls 171′, 172′ and arranged at the rear of the walls 171′, 172′ and engaging the opening 84′ of the plate 87′ when the side 108′, 109′ is connected to the bracket 86′; and
a pair of walls 174′, 175′ parallel to and spaced apart from each other, that lie orthogonal to the axis Z, and extend one (174′) between the walls 171′, 173′ and the other (175′) between the walls 172′, 173′.

The attachment element 170′ also comprises:
a pair of interfaces 177′ connected to the side 108′, 109′ and fixed to respective walls 171′, 172′;
a pin 178′ that crosses the walls 174′, 175′ orthogonally;
a spring 179′ placed between the pin 178′ and the wall 174′; and
an appendage 165′ projecting so that it overhangs orthogonally to and to the rear of the pin 178′ and can engage, in a sliding manner, a seat 176′ defined by the wall 173′ and extending parallel to the pin 178′

The attachment element 180′ comprises, in turn, a wall 181′ having respective first portions 183′ (only one of which is illustrated in FIG. 13) overlapping each other and connected to the side 108′, 109′ and respective second portions 184′ (only one of which is illustrated in FIG. 13) spaced apart from each other and connected orthogonally by a pin 185′.

The pin 185′ engages the seats 104′ of the bracket 93′ and is arranged parallel to the axis Z, when the side 108′, 109′ is connected to the backrest 42.

The operation of the cockpit 25′ is similar to that of the first cockpit 25 and is only described as far as it differs from this.

The operation of the cockpit 25′ differs from the first cockpit 25 in that the transition from the first, “two-seater” configuration to the second, “single-seater” configuration occurs by removing the sides 98′, 99′, and 108′, 109′ from the cockpit 25′ and connecting them again, in the reverse position, to the cockpit 25′.

More specifically, in the first, “two-seater” configuration, the side 98′ is placed between the seat cushions 30, 32, the side 99′ is placed between the seat cushions 32, 31, the side 108′ is placed between the backrests 40, 42, and the side 109′ is placed between the backrests 42, 41.

If one wishes to reconfigure the motor vehicle 1, so as to arrange the cockpit 25′ in the second, “single-seater” configuration, it is enough:
to decouple the holes 130′ from the respective brackets 140′ and the attachment elements 131′ from the respective brackets 150′, so as to remove the sides 98′, 99′ from the corresponding guides 85′;
to decouple the attachment elements 170′ from the respective brackets 86′ and the attachment elements 171′ from the respective brackets 93′, so as to remove the sides 108′, 109′ from the cockpit 25′; and
to arrange the side 99′ placed between the seat cushions 30, 32, the side 98′ placed between the seat cushions 32, 31, the side 109′ placed between the backrests 40, 42, and the side 108′ placed between the backrests 42, 41 along the axis Y.

More precisely, the sides 99′, 98′ are first brought near the respective guides 85′ in a position respectively interposed between the seat cushions 30, 32, and 32, 31.

Following this, the pins 135′ of the attachment elements 131′ are inserted so that they can slide parallel to the axis Y inside the seats 153′ of corresponding brackets 150′, keeping the sides 98′, 99′ tilted downwards moving from the respective front holes 130′ towards the respective rear attachment elements 131′.

Once the pins 135′ have reached the respective end-stroke positions inside the seats 153′, the sides 98′, 99′ are rotated before bringing the holes 130′ near to the corresponding brackets 140′ and, following this, engaging the pins 149′ of the brackets 140′ inside the holes 130′.

At this point, the sides 98′, 99′ are fixed to the corresponding guides 85′.

The sides 108′, 109′ are first brought near the brackets 86′, 93 in a position respectively interposed between the backrests 40, 42 and 42, 41.

Following this, the pins 185′ of the attachment elements 180′ are inserted inside the seats 104′ of the brackets 93′ and pushed below parallel to the axis Z until they reach respective end-stroke positions.

At this point, the sides 108′, 109′ are rotated so as to bring the attachment elements 170′ near the corresponding brackets 86′ and to insert the walls 173′ inside the openings 84′ of the plate 87′ of the corresponding brackets 86′.

The elastic action exerted by the spring 179′ on the pins 178′ pushes the respective appendages 165′ towards the lower ends of the corresponding seats 176′, elastically keeping the walls 173′ inside the openings 84′.

Upon reaching the second, “single-seater” configuration, the sides 98′, 99′ and 108′, 109′ also diverge, moving from the respective edges 160′ towards the corresponding edges 161′.

The advantages enabled by this invention will be apparent from an examination thereof.

More specifically, the cockpit 25, 25′ can be moved between the first, “two-seater” configuration wherein it defines the seat 27 for the driver and the seat 26 for the passenger, and the second, “single-seater” configuration wherein it defines just the seat 28 for the driver, simply by acting on the sides 98, 99; 98′, 99′; 108, 109; 108′, 109′.

In this way, the motor vehicle I can be quickly and simply made more suitable for road use when the cockpit 25, 25′ assumes the first, “two-seater” configuration or for sports use wherein the cockpit 25, 25′ assumes the second, “single-seater” configuration.

The cockpit 25 can be moved between the above-mentioned first, “two-seater” configuration and a second, “single-seater” configuration, simply by rotating the sides 99; 98′, 99′; 108, 109; 108′, 109′ around the corresponding edges 160.

The cockpit 25′ can be moved between the above-mentioned first, “two-seater” configuration and a second, “single-seater” configuration, simply by exchanging the sides 98, 99; 98′, 99′; 108, 109; 108′, 109′.

The sides 98′, 99′; 108′, 109′ are connected, so that they can be released, to the guides 85′ and to the brackets 86′, 93′, already normally present in a conventional frame, thus not requiring changes to the design of the frame 29′.

Finally, it is clear that changes may be made to the cockpit 25′, 25′ and to the reconfiguration method implemented according to this invention, and variations produced thereto that, in any case, do not depart from the scope of protection defined by the claims.

In particular, in the first, “two-seater” configuration, the seat 27 for the driver could be arranged facing the door sill 24 and the seat 26 for the passenger could be arranged facing the door sill 23, thus implementing a right-hand drive mode in the motor vehicle 1.

1. A cockpit (25, 25′) for a motor vehicle (1), comprising:
a frame (29, 29′), which can be fixed to said motor vehicle (1);
a first and a second seat cushion (30, 31);
a first and a second backrest (40, 41); and
a first side (98, 99; 108, 109) and a second side (98′, 99′; 108′, 109′);
said cockpit (25, 25′) being available in a a first configuration, wherein:
said first seat cushion (30), said first backrest and said first side (98, 108; 99′; 108′) define a first seat (26) for one of a passenger and a driver; and
said second seat cushion (31), said second backrest (41) and said second side (99, 109; 99′, 109′) define a second seat (27) for the other one of said passenger and said driver;
said first and second seats (26, 27) being spaced apart from one another;
said first side (98, 108; 99′; 108′) delimiting said first seat (26) on the side of said second seat (27) in said first configuration;
said second side (98, 108; 99′; 108′) delimiting said second seat (27) on the side of said first seat (26) in said first configuration;
said first side (98, 108; 99′, 108′) and said second side (99, 109; 99′, 109′) each comprising a respective first edge (160, 160′), which is constrained to said cockpit (25, 25′), and a respective second edge (161, 161′), which is opposite the respective first edge (160, 160′) and is free;
said first side (98, 108; 99′, 108′) and said second side (99, 109; 99′, 109′) converging towards one another in said first configuration of said cockpit (25, 25′), moving from the respective first edges (160, 160′) to the corresponding second edges (161, 161′);
characterized in that it comprises:
a third seat cushion (32) interposed between said first and second seat cushions (30, 31);
a third backrest (42) at least partly interposed between said first and second backrests (40,

41.;
said cockpit (25, 25′) being movable to a second configuration, wherein said third seat cushion (32), said third backrest (42) and said first side (98, 108; 99′, 108′) and second side (99, 109; 99′, 109′) define one single third seat (28) for a driver;
said first side (98, 108; 99′, 108′) and said second side (99, 109; 99′, 109′) being interposed between said first seat (30) and said third seat (32) and between said third seat (32) and said second seat (31), respectively;
said first side (98, 108; 99′, 108′) and said second side (99, 109; 99′, 109′) diverging from one another in said second configuration of said cockpit (25, 25′), moving from the respective first edges (160, 160′) to the corresponding second edges (161, 161′).

2. The cockpit according to claim 1, characterized in that said first and second sides (98, 108; 99, 109) can rotate relative to the respective first and second seat cushions (30, 31) or said first and second backrests (40, 41) can rotate between a first and a second position assumed when said cockpit (25) is in said first and second configuration, respectively.

3. The cockpit according to claim 2, characterized in that said first and second sides (108, 109) can rotate relative to the respective first and second backrests (40, 41);
each one of said first and second sides (108, 109) comprising, in turn:
a respective first half-side (108a, 109a), which can rotate around a first axis (C, D); and
a respective second half-side (108b, 109b), which can rotate around a respective second axis (E, F).

4. The cockpit according to claim 1, characterized in that said first side (98′; 108′) and said second side (99′; 109′) are connected to said frame (29′) in a releasable manner;
said first side (99′; 108′) delimiting said second seat (26) on the side of said first seat (27) in said second configuration;
said second side (99′; 108′) delimiting said first seat (27) on the side of said second seat (26) in said second configuration.

5. The cockpit according to claim 4, characterized in that said first side (98′) and said second side (99′) laterally delimit said first and second seat cushions (30, 31), respectively, in said first configuration and delimit said second seat cushion (31) and said first seat cushion (30), respectively, in the second configuration;
said frame (29′) comprising:
at least one guide (85′) elongated along a third axis (X);
at least one first bracket (150′) defining a first seat (153′) elongated along said third axis (X) and fixed to said guide (85′); and
at least one second bracket (140′), which is spaced apart from said first bracket (150′) along said third axis (X), defines a first pin (149′) elongated along a fourth axis (Y) transverse to said third axis (X) and is fixed to said guide (85′);
each one of said first side (98′) and said second side (99′) comprising, in turn:
a first attachment element (131′) comprising a second pin (135′), which can be engaged, in a sliding manner, inside said first seat (153′); and
a second attachment element (130′), which is spaced apart from said first attachment element (131′) and can be engaged by said first pin (149′).

6. The cockpit according to claim 5, characterized in that it comprises a third side (108′) and a fourth side (99′), which laterally delimit said first and second backrests (40, 41), respectively;
said frame (29′) comprising, in turn:
at least one third bracket (86′) defining a second seat (84′); and
at least one fourth bracket (93′), which is spaced apart from said third bracket (86′) and defines at least one third seat (104′);
each one of said third side (108′) and said fourth side (109′) comprising, in turn:
a third attachment element (170′), which can be engaged, in a sliding manner, inside said third seat (84′); and
a fourth attachment element (180′), which is spaced apart from said third attachment element (170′) and can be engaged inside said at least one fourth seat (104′).

7. The cockpit according to claim 6, characterized in that said third bracket (86′) is interposed between said first backrest (40) and said third backrest (42) and in that it comprises a further third bracket (86′) interposed between said third backrest (42) and said second backrest (41); said third brackets (86′) being spaced apart from one another along said fourth axis (Y);
said fourth bracket (93′) being interposed between said first backrest (40) and said third backrest (42);
said cockpit (25′) further comprising a further fourth bracket (93′) interposed between said third backrest (42) and said second backrest (41); said fourth brackets (93′) being spaced apart from one another along said fourth axis (Y).

8. The cockpit according to claim 1, characterized in that it comprises a fifth side (97, 107; 97′, 107′) and a sixth side (100, 110; 100′, 110′) fixed to the cockpit (25, 25′) itself;
said first side (98, 108; 98′, 108′) and said fifth side (97, 107; 97′, 107′) laterally delimiting, on opposite sides, the corresponding first seat cushion (30, 31) or said first backrest (40, 41) and diverging from one another moving from the respective first edges (160, 160′) to the corresponding second edges (161, 161′) in said first configuration of said cockpit (25, 25′);
said second side (99, 109; 99′, 109′) and said sixth side (100, 110; 100′, 110′) laterally delimiting, on opposite sides, the corresponding second seat cushion (30, 31) or said second backrest (40, 41) and diverging from one another moving from the respective first edges (160, 160′) to the corresponding second edges (161, 161′) in said first configuration of said cockpit (25, 25′).

9. A motor vehicle (1) comprising:
a passenger compartment (3);
a plurality of driving members (10; 11, 12), which are housed inside said passenger compartment (3) and can be operated by a driver in order to control the trajectory and the speed of said motor vehicle (1);
at least one control member (6, 7, 9, 21) connected to at least one driving member (10; 11,

12. through a drive by wire mode; and
a cockpit (25, 25′) according to claim 1.

10. A method for the configuration of a cockpit (25, 25′) for a motor vehicle (1);
said cockpit (25, 25′) comprising:
a frame (29, 29′), which can be fixed to said motor vehicle (1);
a first and a second seat cushion (30, 31); and
a first and a second backrest (40, 41);
a first side (98, 108; 98′, 108′) and a second side (99, 109; 99′, 109′);
said method comprising the step i) of arranging said cockpit (25, 25′) to a first configuration, wherein:
said first seat cushion (30), said first backrest and said first side (98, 108; 99′, 108′) define a first seat (26) for one of a driver and a passenger; and
said second seat cushion (31), said second backrest (41) and said second side (99, 109; 99′, 109′) define a second seat (27) for the other one of said driver and said passenger;
said first and second seats (26, 27) being spaced apart from one another;
said first side (98, 108; 99′; 108′) delimiting said first seat (26) on the side of said second seat (27) in said first configuration;
said second side (98, 108; 99′; 108′) delimiting said second seat (27) on the side of said first seat (26) in said first configuration;
said first side (98, 108; 99′; 108′) and said second side (99,109; 99′, 109′) each comprising a respective first edge (160, 160′), which is constrained to said cockpit (25, 25′), and a respective second edge (161, 161′), which is opposite the respective first edge (160) and is free;
said first side (98, 108; 99′; 108′) and said second side (99, 109; 99′, 109′) converging towards one another in said first configuration of said cockpit (25, 25′), moving from the respective first edges (160, 160′) to the corresponding second edges (161, 161′);
characterized in that it comprises the step ii) of shifting said cockpit (25, 25′) to a second configuration, wherein a third seat cushion (32), a third backrest (42) and said first side (98, 108; 98′, 108′) and second side (99, 109; 99′, 109′) define one single third seat (28) for a driver;
said third seat cushion (32) being interposed between said first and second seat cushions (30, 31);
said third backrest (42) being at least partly interposed between said first and second backrests (40, 41);
said first side (98; 108; 99′; 108′) and said second side (99; 109; 99′, 109′) being interposed between said first seat (30) and said third seat (32) and between said third seat (32) and said second seat (31), respectively;
said first side (98; 108; 99′; 108′) and said second side (99; 109; 99′, 109′) diverging from one another in said second configuration of said cockpit (25, 25′), moving from the respective first edges (160, 160′) to the corresponding second edges (161, 161′).

11. The method according to claim 10, characterized in that it comprises the step iii) of rotating said first and second sides (98, 108; 99, 109) relative to the respective first and second seat cushions (30, 31) or said first and second backrests (40, 41) between a first and a second position assumed when said cockpit (25) is in said first and second configuration, respectively.

12. The method according to claim 10, characterized in that it comprises the steps of:
iv) connecting said first side (98′, 108′) and said second side (99′, 109′) to said frame (29) in a releasable manner;
v) placing said first side (98′, 108′) on a first side of said third seat (32) and said second side (99′; 109′) on a second side of said third seat (32) opposite said first side, when said cockpit (25′) is in said first configuration;
vi) switching said first side (98′, 108′) and said second side (99′, 109′) in order to shift said cockpit (25′) from said first configuration to said second configuration.

13. The method according to claim 12, wherein said first side (98′) and said second side (99′) laterally delimit said first and second seat cushions (30, 31), respectively;
said method being characterized in that step iv) comprises the steps of:
v) inserting a first pin (135′) of a first side (98′) in a sliding manner into a first seat (153′) elongated along a first axis (X) and defined by a first bracket (150′) of said frame (29′);
vi) rotating said first side (98′) towards a second bracket (140′) of said frame (29′), once said first pin (135′) has reached a limit stop position inside said first seat (153′); said second bracket (140′) being spaced apart from said first bracket (150′) along said first axis (X) and comprising a second pin (149′); and
vii) coupling said second pin (149′) to a hole (130′) carried by said first side (98′) and spaced apart from said first pin (135′).

14. The method according to claim 12, characterized in that said cockpit (25′) comprises a third side (108′) and a fourth side (109′), which laterally delimit said first and second backrests (40, 41);
said method comprising the steps of:
viii) inserting a third pin (185′) carried by said third side (108′) in a sliding manner into a second seat (104′) defined by a third bracket (94′) of said frame (29′);
ix) rotating said third side (108′) towards a fourth bracket (86′) of said frame (29′), once said third pin (185′) has reached a limit stop position inside said second seat (104′); said fourth bracket (86′) being spaced apart from said third bracket (94′) and defining a third seat (84′); and
x) coupling an engagement element (173′) carried by said third side (108′) and spaced apart from said third pin (185′) inside said third seat (84′).
